(19) United States
(12) Patent Application Publication
(10) Pub. No.: US 2026/0224081 A1
(43) Pub. Date: Aug. 6, 2026

(54) VACUUM CLEANER

(71) Applicant: LG ELECTRONICS INC., Seoul (KR)

(72) Inventors: Inkyu HWANG, Seoul (KR); Kietak HYUN, Seoul (KR); Jaehun HAN, Seoul (KR); Junhyung LIM, Seoul (KR)

(21) Appl. No.: 19/148,050

(22) PCT Filed: Jun. 28, 2023
(86) PCT No.: PCT/KR2023/009022

§ 371 Date: Jul. 15, 2025

(30) Foreign Application Priority Data
May 31, 2023 (KR) 10-2023-0070021

(51) Int. Cl. A47L 9/16; B04C 5/103; B04C 5/13; B04C 5/26

(52) U.S. Cl. CPC A47L 9/1608; A47L 9/1625; B04C 5/103; B04C 5/13; B04C 5/26; B04C 2005/136

(57) ABSTRACT

The embodiments of the present disclosure may relate to a cleaner that includes a suction port configured to guide air into a dust bin; a first cyclone part configured to separate dust from air sucked in through the suction port; and a second cyclone part configured to separate dust from air discharged from the first cyclone part, and the second cyclone part may include a cyclone body configured to receive air discharged from the first cyclone part; a vortex finder having at least a portion disposed on the inside of each cyclone body; and a guide vane member having at least a portion disposed between the cyclone body and the vortex finder, and configured to guide air discharged from the first cyclone part to the inside of the cyclone body, and the guide vane member may include a first guide vane disposed in the cyclone body; and a second guide vane disposed in the vortex finder, and the first guide vane and the second guide vane may be in contact and extend continuously.

### BACKGROUND

### Technical Field

Embodiments of the present disclosure relate to a cleaner.

### Background of the Disclosure

Generally, a cleaner is an electrical appliance configured to suck in small pieces of trash or dust by sucking air and filling a dust bin provided therein, and is commonly called a vacuum cleaner.

Such vacuum cleaners may be classified into manual cleaners that perform cleaning while the user moves the cleaner, and automatic cleaners that perform cleaning while driving on their own. The manual vacuum cleaners may be classified into canister type vacuum cleaners, upright type vacuum cleaners, handheld vacuum cleaners and stick type vacuum cleaners, depending on the shape

In the past, canister-type vacuum cleaners were widely used for home vacuum cleaners, but recently, handheld vacuum cleaners stick type vacuum cleaners, which can a dust bin and vacuum cleaner body as one unit to improve convenience, are being widely used.

A canister-type vacuum cleaner has a cleaner body and a suction inlet that are connected by a rubber hose or pipe, and in some cases, a brush may be fitted to the suction inlet for use.

A hand vacuum cleaner is designed to maximize portability. The hand vacuum cleaner is light in weight but short in length, so the cleaning area may be limited when sitting down. Accordingly, it is used to clean localized areas such as a desk, sofa or inside a car.

A stick vacuum cleaner may be used standing up so a user can clean without bending down. This makes the stick vacuum cleaner ideal for cleaning wide areas while moving around. While the hand vacuum cleaner can clean narrow spaces, the stick vacuum cleaner can clean wider spaces and high places that are hard to reach. Recently, the stick vacuum cleaner is being provided in modular form, allowing user to actively change the vacuum cleaner type for user on various cleaning targets.

Cyclones used in vacuum cleaners may be classified into vertical cyclones and axial cyclones depending on the direction of air inflow.

The structure of the vertical cyclone may be found in Korean Patent Publication No. 10-0673769 (hereinafter, Patent Document 1). According to the disclosure in Patent Document 1, a vertical cyclone is provided with a vertical guide to form a spiral flow. In the case of the vertical cyclone, air is introduced in the vertical direction of the outer surface through structures such as the vertical guide, and the spiral flow is formed by a structure that introduces air in the vertical direction. The vertical cyclone has the advantage of a simple structure and is advantageous in that it is suitable for installation in a limited space such as a vacuum cleaner because it is advantageous in a circular arrangement. However, the vertical cyclone has a disadvantage in that a large pressure loss occurs due to a high-speed flow that is eccentric to one side.

The structure of the axial cyclone may be found in Korean Patent Publication No. 10-2008-0108284 (hereinafter, Patent Document 2). According to the disclosure in Patent Document 2, the axial cyclone is provided with a spiral ramp for forming a spiral flow. In the case of the axial cyclone, the flow is introduced in the axial direction, and the axial cyclone is configured to generate a swirling flow by using a spiral ramp, etc. The axial cyclone has the advantage of an appropriate flow velocity and uniform suction compared to a tangential inflow cyclone, and thus has the advantage of low pressure loss. On the other hand, the axial cyclone has the disadvantage of being difficult to manufacture a guide vane.

In order to improve the overall efficiency of the cleaner by reducing pressure loss as much as possible, it is desirable to use an axial cyclone. However, conventional cleaners using the axial cyclone had the following problems.

First, as disclosed in Patent Document 2, conventional cleaners having multiple axial cyclones are formed by having multiple separately manufactured axial cyclones come together to separate dust. The axial cyclones are each manufactured separately in a mold of the same shape so that they have the same shape. Since each axial cyclone manufactured in the mold has a gap between guide vanes, it has the disadvantage that the separation performance is inevitably reduced due to its structure.

In addition, since the cleaner is a mass-produced product, each axial cyclone goes through an assembly process after mass production. It is expected that the axial cyclone disclosed in Patent Document 2 will also go through this process. Each axial cyclone is formed by separately producing a vortex finder equipped with a guide vane and an outer wall, and then inserting and assembling the vortex finder into the inner side of the outer wall. Therefore, there was the inconvenience of the assembly process of each axial cyclone.

Furthermore, axial cyclones produced in molds had the disadvantage of not having a complex shape to implement high separation performance. Axial cyclones are generally produced by an upper mold and a lower mold, but it is difficult for axial cyclones to have a complex shape due to the limitations of being produced in a mold.

### DETAILED DESCRIPTION OF THE INVENTION

### Technical Problems

Accordingly, one object of the present disclosure is to solve the above-noted disadvantages of the prior art, and to provide a cleaner that including axial cyclones with a structure in which guide vanes overlap each other in one direction to solve the problem of reduced separation performance of the cyclone section caused by the gap between guide vanes.

Another object of the present disclosure is to provide a cleaner that may maximize the length of the guide path that guides air into the inside of the cyclone body.

A further object of the present disclosure is to provide a cleaner that may reduce the flow loss of air flowing through the guide path by stably coupling the manufactured guide vanes.

A still further object of the present disclosure is to provide cleaner that may reduce the loss of air flow through the vortex finder.

### Technical Solutions

To solve the objects of the present disclosure, a cleaner according to embodiments may include a suction port configured to guide air into a dust bin; a first cyclone part configured to separate dust from air sucked in through the suction port; and a second cyclone part configured to separate dust from air discharged from the first cyclone part. The second cyclone part may include a cyclone body configured to receive air discharged from the first cyclone part; a vortex finder having at least a portion disposed on the inside of each cyclone body; and a guide vane member having at least a portion disposed between the cyclone body and the vortex finder, and configured to guide air discharged from the first cyclone part to the inside of the cyclone body, and the guide vane member may include a first guide vane disposed in the cyclone body; and a second guide vane disposed in the vortex finder, and the first guide vane and the second guide vane may be in contact and extend continuously.

The guide vane member may further include a third guide vane arranged in the vortex finder so as to be spaced adjacent to the second guide vane, and the first guide vane and the third guide vane overlap each other along the coupling direction of the cyclone body and the vortex finder.

Air discharged from the first cyclone part may be introduced into the inside of the cyclone body through a guide path formed by the vortex finder and the guide vane member, and the guide path may extend along a spiral direction.

An inner surface of the vortex finder corresponding to the second guide vane may protrude outward.

The area of the outlet of the above vortex finder may be larger than the area of the inlet of the above vortex finder.

One side of the guide vane member may be connected to an outer surface of the vortex finder along a spiral direction, and the other side of the guide vane member may be connected to an inner surface of the cyclone body along a spiral direction.

The first guide vane and the above second guide vane may be formed to be in surface contact.

The second guide vane may be formed with a step having a shape corresponding to an edge of one outer surface of the first guide vane.

The step of the second guide vane may include a first surface corresponding to an upper surface of the first guide vane; and a second surface corresponding to a side surface of the first guide vane and bent downward from the first surface, and the first guide vane may be in surface contact with the first surface and the second surface.

The second surface may be formed parallel to a coupling direction of the cyclone body and the vortex finder.

At least a portion of the outer surface of the above vortex finder may be recessed inward to correspond to the first guide vane.

### ADVANTAGEOUS EFFECTS

As described above, according to the cleaner according to the embodiments of the present disclosure, the structure is formed in which one guide vane overlaps another guide vane in one direction, thereby having the effect of solving the problem of reduced separation performance of the cyclone section caused by the gap between the guide vanes.

Furthermore, the cleaner according to the present disclosure has the effect of maximizing the length of the guide path for generating cyclone flow by connecting separately manufactured guide vanes.

Still further, the cleaner according to the embodiments of the present disclosure has the structure in which one guide vane is coupled to another guide vane, thereby enabling stable coupling between the guide vanes and reducing the flow loss of air flowing into the inside of the cyclone body.

Still further, the cleaner according to the embodiments of the present disclosure has the effect of reducing flow loss that occurs when air passes through a vortex finder as the cross-sectional area of the flow path becomes wider from the inlet to the outlet of the vortex finder.

### DESCRIPTION OF DRAWINGS

FIGS. 1 and 2 are diagrams to describe a cleaner in a cleaner system according to embodiments of the present disclosure;

FIG. 3 is a diagram to describe a lower surface of a dust bin of a cleaner according to embodiments of the present disclosure;

FIG. 4 is an exploded view of a cleaner according to embodiments of the present disclosure;

FIG. 5 is a perspective view of a second cyclone part according to embodiments of the present disclosure;

FIG. 6 is an exploded perspective view of FIG. 5:

FIG. 7 is a front view of FIG. 6;

FIG. 8 is a perspective view to describe that a second cyclone part and a filter part are coupled according to embodiments of the present disclosure;

FIG. 9 is a perspective view of a bottom surface of a dust separation unit according to embodiments of the present disclosure;

FIG. 10 is a front view of a dust separation unit according to embodiments of the present disclosure; and

FIG. 11 is a diagram to describe air flow sucked into a cyclone body according to embodiments of the present disclosure.

### DESCRIPTION OF SPECIFIC EMBODIMENTS

Description will now be given in detail according to exemplary embodiments disclosed herein, with reference to the accompanying drawings.

The present disclosure may be variously modified and may have various embodiments, and particular embodiments illustrated in the drawings will be specifically described below. The description of the embodiments is not intended to limit the present disclosure to the particular embodiments, but it should be interpreted that the present disclosure is to cover all modifications, equivalents and alternatives falling within the spirit and technical scope of the present disclosure.

Terminology that is used in the present disclosure is limited to only for embodiments herewith but made only to make it easy to understand the present disclosure. A singular representation may include a plural representation unless it represents a definitely different meaning from the context. In understanding the components, it should be understood as including the error range even if there is no separate explicit description.

Terms of respective elements used in the following description are terms defined taking into consideration of the functions obtained in the present invention. Therefore, these terms do not limit technical elements in the present invention. Further, the defined terms of the respective elements will be called other terms in the art.

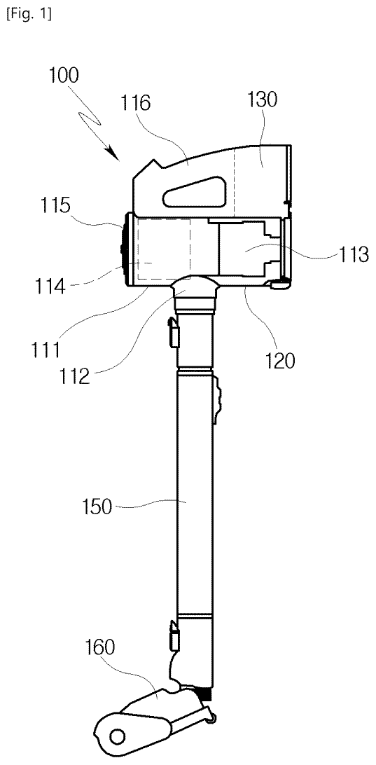

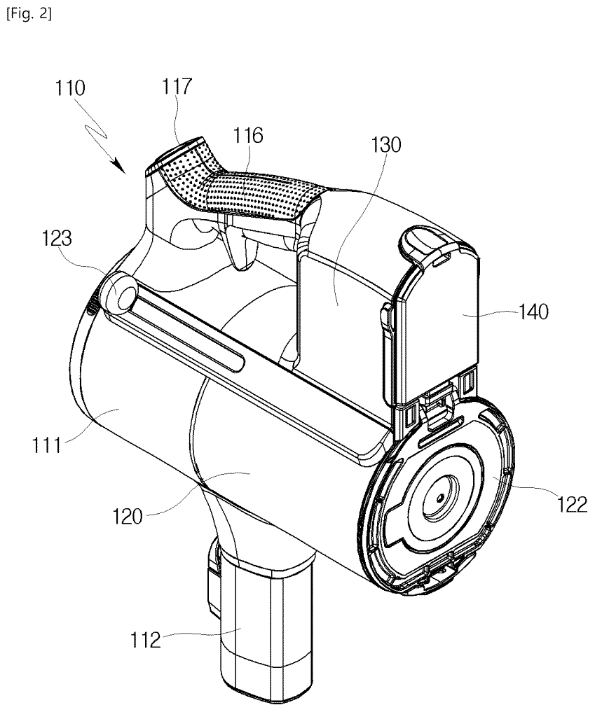

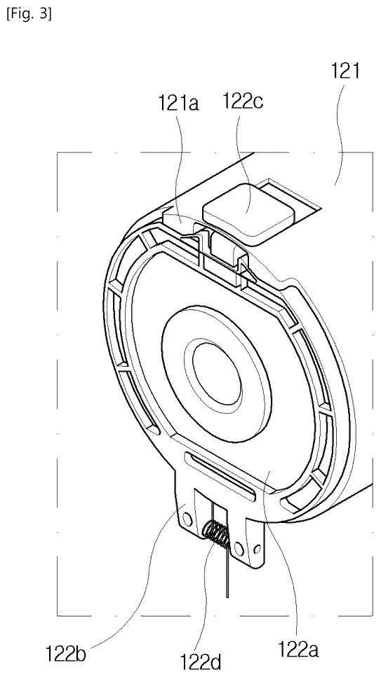

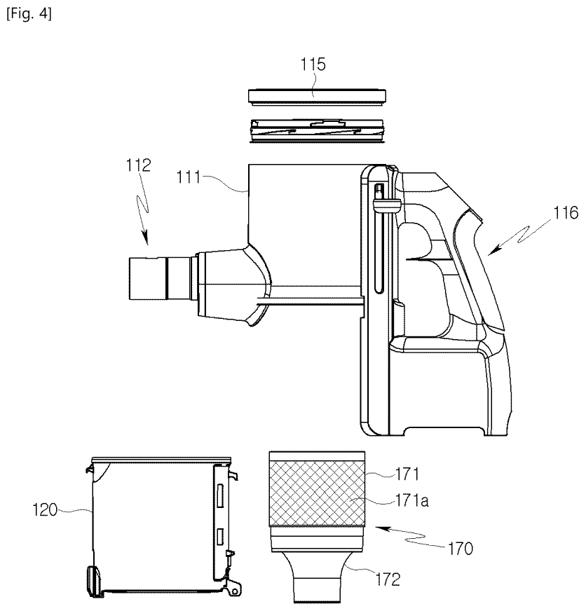

FIGS. 1 and 2 are diagrams to describe a cleaner in a cleaner system according to embodiments of the present disclosure. FIG. 3 is a diagram to describe a lower surface of a dust bin of a cleaner according to embodiments of the present disclosure. FIG. 4 is an exploded view of a cleaner according to embodiments of the present disclosure.

Referring to FIGS. 1 to 4, the structure of the cleaner 100 will be described as follows.

The cleaner 100 may mean a vacuum cleaner that is manually operated by a user. For example, the cleaner 100 may mean a hand vacuum cleaner or a stick vacuum cleaner.

Meanwhile, in one embodiment of the present invention, the direction of the cleaner 100 may be defined based on the time when the bottom surface (lower surface) of a dust bin 120 and a battery housing 130 are placed on the ground.

At this time, the front or forward may refer to the direction in which a suction port 112 is arranged based on a suction motor 114, and the rear or rearward may refer to the direction in which a handle 116 is arranged based on the suction motor 114. In addition, the direction in which the suction port 112 is arranged on the right side when viewed from the suction motor 114 may be referred to as the right side, and the direction in which the suction port 112 is arranged on the left side may be referred to as the left side. In addition, in one embodiment of the present invention, the upper and lower sides or upward and downward may be defined along the direction perpendicular to the ground when the bottom surface (lower surface) of the dust bin 120 and the battery housing 130 are placed on the ground.

The cleaner 100 may include a cleaner body 110. The cleaner body 110 may include a cleaner body housing 111, a suction port 112, a first cyclone part 113, a suction motor 114, an air discharge cover 115, a handle 116, and a manipulation part 117.

The cleaner body housing 111 may form the exterior of the cleaner 100. The cleaner body housing 111 may provide a space that may accommodate the suction motor 114 and a filter (not shown) inside. The cleaner body housing 111 may be configured in a shape similar to a cylinder.

The suction port 112 may protrude outwardly from the cleaner body housing 111. For example, the suction port 112 may be formed in a cylindrical shape with an open interior. The suction port 112 may be coupled to an extension pipe 150. The suction port 112 may provide a path through which air containing dust may flow. The suction port 112 may be connected to the cleaner body 110 so that its central portion is located roughly at the boundary between the dust bin 120 and the cleaner body housing 111.

Meanwhile, in this embodiment, a virtual line penetrating the inside of the suction port 112 configured in a cylindrical shape may be formed. At this time, the virtual line can mean the longitudinal axis of the suction path.

The cleaner 100 according to the embodiment of the present invention may be provided with at least one cyclone part capable of separating dust by cyclone flow. For example, the cleaner 100 may include a first cyclone part 113 and a second cyclone part 200.

The first cyclone part 113 may be communicated with the suction port 112. The first cyclone part 113 may separate dust sucked into the inside through the suction port 112. The space inside the first cyclone part 113 may be communicated with the space inside the dust bin 120.

The first cyclone part 113 is connected to the suction port 112 and is configured to apply the principle of a dust collector that uses centrifugal force to separate dust sucked into the interior of the cleaner body 110 through the suction port 112. In other words, the first cyclone part 113 refers to a space in which a cyclone flow that rotates along the inner surface of the dust bin 120 occurs, and the first cyclone part 113 may refer to a portion of the space inside the dust bin 120.

The cyclone flow generated in the first cyclone part 113 may be due to the suction force of the suction motor 114.

The cyclone flow generated in the first cyclone part 113 may be formed between the inner circumference of the dust bin 120 and the outer circumference of the filter body 171 described below. That is, the above cyclone flow may be formed inside the first cyclone part 113.

The space inside the first cyclone part 113 may be connected to the suction port 112. The air and dust sucked through the suction port 112 flow along the inner surface of the first cyclone part 113, and thus, a cyclone flow may occur in the inner space of the first cyclone part 113.

For example, the cyclone flow generated in the first cyclone part 113 may be formed to surround the outer perimeter of the filter body 171 in a circular shape. That is, the air sucked through the suction port 112 flows in a circular shape along the outer surface of the filter body 171 based on the central axis of the filter body 171, and thus, a cyclone flow may occur in the inner space of the first cyclone part 113.

Specifically, when the axis of the cyclone flow generated in the first cyclone part 113 is arranged vertically below the direction of gravity, the air sucked through the suction port 112 may flow in a circular shape along the outer surface of the filter body 171 based on the central axis of the filter body 171. Alternatively, when the axis of the cyclone flow generated in the first cyclone part 113 is arranged parallel to the ground, the air sucked through the suction port 112 may flow in a circular shape along the outer surface of the filter body 171 based on the central axis of the filter body 171.

As another example, the cyclone flow generated in the first cyclone part 113 may be formed in a spiral shape along the outer perimeter of the filter body 171. That is, the air sucked through the suction port 112 flows in a spiral manner along the outer circumference of the filter body 171, thereby allowing cyclonic flow to occur in the internal space of the first cyclone part 113. Accordingly, cyclonic flow may occur in the internal space of the first cyclone part 113.

Specifically, when the axis of the cyclone flow generated in the first cyclone part 113 is arranged to be inclined with respect to the ground, the air sucked through the suction port 112 may flow in a spiral shape along the outer circumference of the filter body 171.

The cleaner 100 according to the embodiment of the present invention may include a second cyclone part 200 that re-separates dust from the air discharged from the first cyclone part 113. That is, the second cyclone part 200 may filter out small dust that the first cyclone part 113 and the filter part 170 could not filter out from the air that passed through the first cyclone part 113 and the filter part 170.

At this time, the second cyclone part 200 may be positioned inside the first cyclone part 113 so that the size of the cleaner 100 is minimized. The second cyclone part 200 may be positioned below the suction motor 114. Specifically, the second cyclone part 200 may be positioned inside the filter part 170). That is, the first cyclone part 113 and the second cyclone part 200 may be positioned inside the dust bin 120 with the filter unit 170 between them.

The second cyclone part 200 may include a plurality of cyclone bodies 210 that are positioned in parallel. Therefore, the air discharged from the first cyclone part 113 may pass through the filter part 170 and be divided into a plurality of cyclone bodies (210). That is, the cyclone flow generated in the second cyclone part 113 may be formed inside the cyclone body 210.

Meanwhile, the second cyclone part 200 may also include a single cyclone body 210, and in this case, the axis of the cyclone flow generated in the second cyclone part 200 may be extended in the vertical direction.

In addition, the axis of the cyclone flow generated in the first cyclone part 200 may also be extended in the vertical direction. Therefore, the axis of the cyclone flow generated in the first cyclone section 113 and the axis of the cyclone flow generated in the second cyclone part 200 form coaxiality in the vertical direction or be formed in parallel.

A storage member 172 may be placed inside the dust bin 120 to store dust separated from the second cyclone part 200. The storage member 172 may be connected to the lower side of the filter body 171 and may be in contact with the upper surface of the discharge cover 122. In addition, the lower side of the storage member 172 may be opened.

The storage member 172 may divide the space inside the dust bin 120 into a first dust storage where dust separated from the first cyclone part 113 is stored, and a second dust storage where dust separated from the second cyclone part 200 is stored.

Therefore, the space between the storage member 172 and the dust bin 120 may be defined as the first dust storage unit, and the lower internal space of the storage member 172 may be defined as the second dust storage.

The discharge cover 122 may open and close the first dust storage unit and the second dust storage unit together. In other words, the first dust storage unit and the second dust storage unit can be exposed to the outside together.

The suction motor 114 may generate a suction force to suck in air. The suction motor 114 may be accommodated in the cleaner body housing 111. The suction motor 114 may generate a suction force by rotation. For example, the suction motor 114 may be provided in a similar cylindrical shape.

At this time, a cyclone flow may be generated by the suction force of the suction motor 114.

Specifically, when the suction motor 114 is operated, the air sucked through the suction port 112 by the suction force of the suction motor 114 may generate a cyclone flow in the first cyclone part 113 and/or the second cyclone part 200.

Meanwhile, in the present embodiment, a rotation axis of a virtual suction motor may be formed by extending the rotation axis of the suction motor 114.

The suction motor 114 may be located inside the cleaner body housing 111. And, at least a portion of the suction motor 114 may be located above the second cyclone part 200. Therefore, the suction motor 114 may be located above the dust bin 120.

The suction motor 114 may be connected to the outlet 221b of the second cyclone part 200.

The axis of the cyclone flow of the first cyclone part 113 may pass through the suction motor 114.

In an embodiment of the present invention, if the suction motor 114 is located above the second cyclone part 200, the air discharged from the second cyclone part 200 may flow directly toward the suction motor 114, so that the flow path between the second cyclone part 200 and the suction motor 114 may be minimized.

The air discharge cover 115 may be arranged on one side of the cleaner body housing 111 in the axial direction. The air discharge cover 115 may accommodate a filter for filtering air. For example, the air discharge cover 115 may accommodate a HEPA filter.

The air discharge cover 115 may be formed with an air discharge hole for discharging air sucked in by the suction force of the suction motor 114.

A flow guide may be arranged on the air discharge cover 115. The flow guide may guide the flow of air discharged through the air discharge hole.

The handle 116 may be held by a user. The handle 116 may be arranged at the rear of the suction motor 114. For example, the handle 116 may be formed in a shape similar to a cylinder. Alternatively, the handle 116 may be formed in a curved cylinder shape. The handle 116 may be arranged at a predetermined angle with respect to the cleaner body housing 111, the suction motor 114, or the first cyclone part 113.

The handle 116 may include a grip portion formed in a column shape so that the user can hold it, a first extension portion connected to one end of the grip portion in the longitudinal direction (axial direction) and formed to extend toward the suction motor 114, and a second extension portion connected to the other end of the grip portion in the longitudinal direction (axial direction) and formed to extend toward the dust bin 120.

Meanwhile, in the present embodiment, a virtual grip portion penetration line may be formed to extend along the longitudinal direction (axial direction of the column) of the grip portion and penetrate the grip portion.

As an example, the grip portion penetration line may be a virtual line formed inside the cylindrical handle 116 and may be a virtual line formed parallel to at least a portion of the outer surface (outer surface) of the grip portion.

The upper surface of the handle 116 may form a part of the outer appearance of the upper surface of the cleaner 100. This prevents the user's arm from contacting one component of the cleaner 100 when the user grips the handle 116.

The first extension portion may extend from the grip portion toward the cleaner body housing 111 or the suction motor 114. At least a portion of the first extension portion may extend in a horizontal direction.

The second extension portion may extend from the grip portion toward the dust bin 120. At least a portion of the second extension portion may extend in a horizontal direction.

The manipulation part 117 may be placed on the handle 116. The manipulation part 117 may be placed on an inclined surface formed in the upper area of the handle 116. The manipulation part 117 may be composed of a plurality of buttons, and when a user presses a corresponding button, a corresponding command may be executed. The user may input an operation or stop command of the cleaner 100 through the manipulation part 117.

The cleaner 100 may include a dust bin 120. The dust bin 120 may be connected to the suction port 112. The first cyclone part 213 may be located inside the dust bin 120. The dust bin 120 may store dust separated from the first cyclone part 213.

The dust bin 120 may include a dustbin body 121, a discharge cover 122, a dust bin compression lever 123, and a compressor (not shown).

The dust bin body 121 may provide a space for storing dust separated from the first cyclone part 113. For example, the dust bin body 121 may be formed in a similar cylindrical shape.

Meanwhile, in the present embodiment, a virtual dustbin penetration line may be formed that penetrates the internal space of the dust bin body 121 and extends along the longitudinal direction of the dust bin body 121 (meaning the axial direction in the cylindrical dust bin body 121).

The lower surface (bottom surface) of the dust bin body 121 may be partially open. In addition, a lower extension portion 121a may be formed on the lower surface (bottom surface) of the dust bin body 121. The extension portion 121a may be formed to block a portion of the lower surface of the dust bin body 121.

The dust bin 120 may include the discharge cover 122. The discharge cover 122 may be arranged on the lower surface of the dust bin 120.

The discharge cover 122 may be provided to open and close one end of the longitudinal direction of the dust bin body 121. Specifically, the discharge cover 122 may selectively open and close the lower part of the dust bin 120 that opens downward.

The discharge cover 122 may include a cover body 122a and a hinge portion 122b. The cover body 122a may be formed to block a portion of the lower surface of the dust bin body 121. The cover body 122a may rotate downward based on the hinge portion 122b. The hinge portion 122b may be arranged adjacent to the battery housing 130. A torsion spring 122d may be provided in the hinge portion 122b. Therefore, when the discharge cover 122 is separated from the dust bin body 121, the cover body 122a may be supported in a state in which it is rotated by a predetermined angle or more about the hinge portion 122b as an axis in the dust bin body 121 by the elastic force of the torsion spring 122d.

The discharge cover 122 may be coupled to the dust bin 120 through a hook connection. Meanwhile, the discharge cover 122 may be separated from the dust bin 120 through a coupling lever 122c. The coupling lever 122c may be arranged at the front of the dust bin 120. Specifically, the coupling lever 122c may be arranged on the outer surface of the front side of the dust bin 120. When an external force is applied, the coupling lever 122c may elastically deform a hook formed by extending from the cover body 122a to release the hook connection between the cover body 122a and the dust bin body 121.

When the discharge cover 122 is closed, the lower surface of the dust bin 120 may be blocked (sealed) by the discharge cover 122 and the lower extension portion 121a.

The dust bin 120 may include the dustbin compression lever 123 (see FIG. 2). The dust bin compression lever 123 may be arranged on the outside of the dust bin 120. The dust bin compression lever 123 may be arranged to move up and down on the outside of the dust bin 120. The dust bin compression lever 123 may be connected to a compressor (not shown). When the dust bin compression lever 123 moves downward by an external force, the compressor (not shown) may also move downward. Through this, convenience for the user may be provided. The compressor (not shown) and the dust bin compression lever 123 may be returned to their original positions by an elastic member (not shown). Specifically, when an external force applied to the dust bin compression lever 123 is removed, the elastic member may move the dustbin compression lever 123 and the compressor (not shown) upward.

The compressor (not shown) may be placed inside the dust bin body 121. The compressor may move in the internal space of the dust bin body 121. Specifically, the compressor may move up and down inside the dust bin body 121. Through this, the compressor may compress dust inside the dust bin body 121 downward. In addition, when the discharge cover 122 is separated from the dust bin body 121 and the lower portion of the dust bin 120 is opened, the compressor may move from the upper portion of the dust bin 120 to the lower part to remove foreign substances such as residual dust inside the dust bin 120. Through this, the suction power of the cleaner may be improved by preventing residual dust from remaining inside the dust bin 120. In addition, by preventing residual dust from remaining inside the dust bin 120, an unpleasant odor caused by residual substances may be eliminated.

The cleaner 100 may include the battery housing 130. The battery housing 130 may accommodate a battery 140. The battery housing 130 may be arranged on the lower side of the handle 116. For example, the battery housing 130 may have a hexahedral shape with an open bottom. The rear side of the battery housing 130 may be connected to the handle 116.

The battery housing 130 may include a receiving portion that opens downward. The battery 140 may be detached through the receiving portion of the battery housing 130.

The battery housing 130 may be provided with a battery terminal exposed to the outside.

When the battery terminal of the battery housing 130 and the external charging terminal (not shown) are combined, power may be supplied to the battery 140 through the battery terminal. The battery terminal may be arranged spaced apart from each other on the lower side of the battery housing 130.

The cleaner 100 may include the battery 140.

For example, the battery 140 may be detachably coupled to the cleaner 100. The battery 140 may be detachably coupled to the battery housing 130. For example, the battery 140 may be inserted into the inside of the battery housing 130 from the bottom of the battery housing 130. With this configuration, the portability of the cleaner 100 may be improved.

Alternatively, the battery 140 may be integrally provided inside the battery housing 130. At this time, the lower surface of the battery 140 is not exposed to the outside.

The battery 140 may store electric energy and may supply power to each component including the suction motor 114 of the cleaner 100. The battery 140 may be placed at the bottom of the handle 116. The battery 140 may be placed at the rear of the dust bin 120. That is, the suction motor 114 and the battery 140 may be placed so as not to overlap in the vertical direction, and may also be placed at different heights. With respect to the handle 116, the suction motor 114, which is heavy, may be placed in front of the handle 116, and the battery 140, which is light, may be placed below the handle 116, so that the weight of the entire cleaner 100 may be evenly distributed. This may prevent the user's wrist from being strained when the user holds the handle 116 and cleans.

According to an embodiment, when the battery 140 is coupled to the battery housing 130, the lower surface of the battery 140 may be exposed to the outside. When the cleaner 100 is placed on the floor, the battery 140 may be placed on the floor, so that the battery 140 may be separated directly from the battery housing 130. In addition, since the lower surface of the battery 140 is exposed to the outside and comes into direct contact with the external air of the battery 140, the cooling performance of the battery 140 may be improved.

Meanwhile, when the battery 140 is integrally fixed to the battery housing 130, the structure for attaching and detaching the battery 140 and the battery housing 130 may be reduced, so that the overall size of the cleaner 100 may be reduced and its weight can be reduced.

The cleaner 100 may include an extension pipe 150. The extension pipe 150 may be connected to the cleaning module 160. The extension pipe 150 may be connected to the cleaner body 110. The extension pipe 150 may be connected to the suction port 112 of the cleaner body 110. The extension pipe 150 may be formed in a long cylindrical shape.

The cleaner body 110 may be connected to the extension pipe 150. The cleaner body 110 may be connected to the cleaning module 160 through the extension pipe 150. The cleaner body 110 may generate suction force through the suction motor 114 and provide suction force to the cleaning module 160 through the extension pipe 150. External dust may be introduced into the cleaner body 110 through the cleaning module 160 and the extension pipe 150.

The cleaner 100 may include the cleaning module 160. The cleaning module 160 may be connected to the extension pipe 150. Therefore, the outside air can be introduced into the cleaner body 110 of the cleaner 100 through the cleaning module 160 and the extension pipe 150 by the suction force generated in the cleaner body 110 of the cleaner 100.

The cleaner according to one embodiment may include the filter part 170.

The filter part 170 may filter air discharged from the first cyclone part 113.

The filter part 170 may guide air separated from dust in the first cyclone part 113 to the second cyclone part 200. That is, the filter part 170 may be a mesh filter having a plurality of holes.

The filter part 170 may include a filter body 171 and a filter hole 171a.

The filter body 171 may be placed inside the dust bin 120. Specifically, the filter body 171 may be disposed inside the first cyclone part 213. The second cyclone part 200 may be disposed inside the filter body 171. That is, the filter body 171 may be provided between the cyclone part 213 and the second cyclone part 200.

The filter body 171 may be formed in a cylindrical shape, although the embodiments are not limited thereto.

The central axis of the filter body 171 may extend in the vertical direction. The central axis of the filter body 171 may extend along the longitudinal direction of the filter body 171.

As an example, the central axis of the filter body 171 may form a coaxial axis with the axis of the cyclone flow generated in the first cyclone part 113. As another example, the central axis of the filter body 171 may be formed parallel to the axis of the cyclone flow generated in the first cyclone part 113.

The filter hole 171a) may guide air into the interior of the filter body 171. The plurality of filter holes 171a may be formed in the longitudinal direction along the outer circumference of the filter body 171. The filter hole 171a is a hole having a predetermined diameter, and large foreign substances contained in the air discharged from the first cyclone part 113 may be filtered by the filter hole 171a.

The air passing through the filter hole 171a may be introduced into the second cyclone part 200 arranged inside the filter body 171.

At this time, the outer side and/or the outside of the filter body 171 may mean the direction facing the cyclone part 213 based on the filter body 171, and the inner side and/or the inside of the filter body 171 may mean the direction facing the second cyclone part 200 based on the filter body 171.

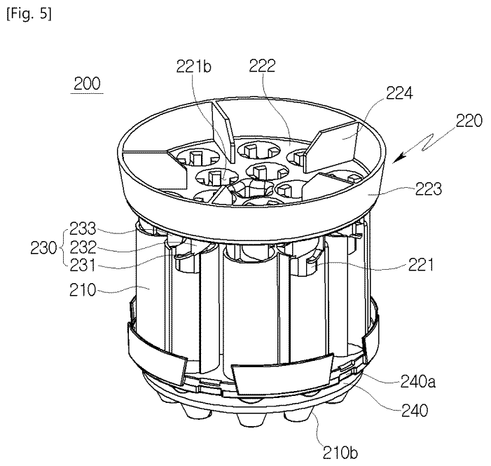

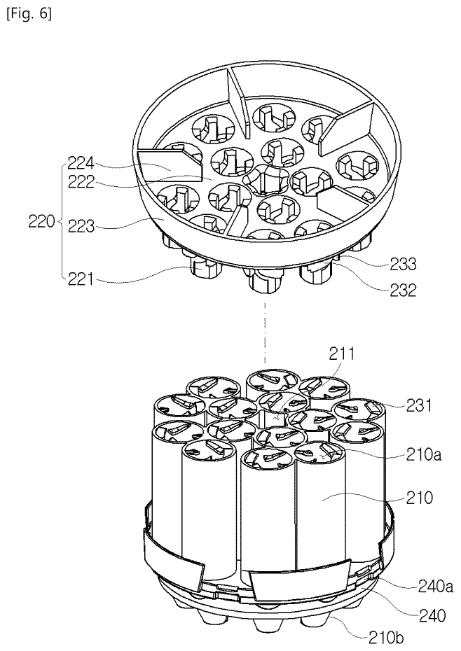

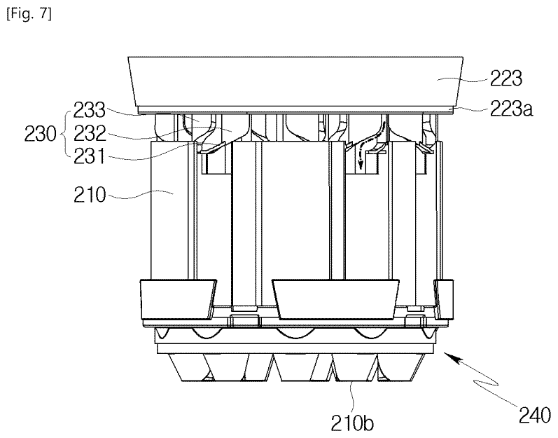

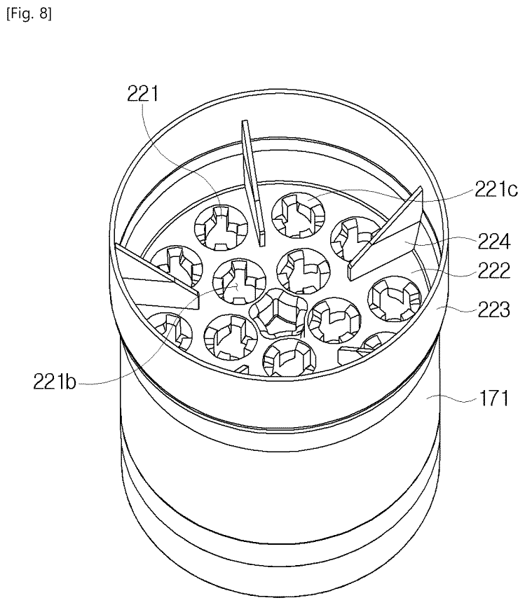

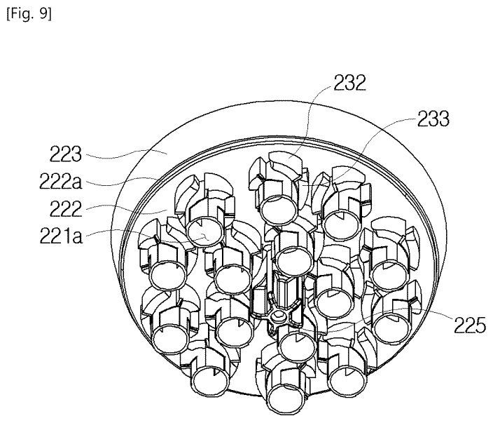

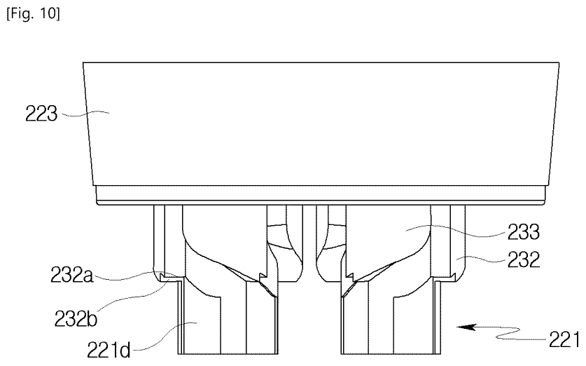

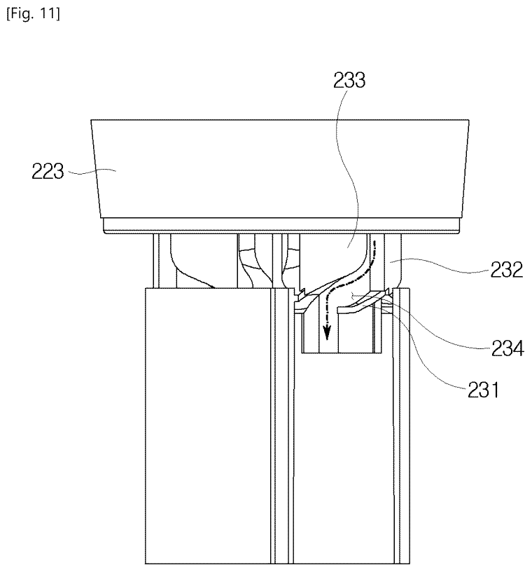

FIG. 5 is a perspective view of a second cyclone part according to embodiments of the present disclosure. FIG. 6 is an exploded perspective view of FIG. 5. FIG. 7 is a front view of FIG. 6. FIG. 8 is a perspective view to describe that a second cyclone part and a filter part are coupled according to embodiments of the present disclosure. FIG. 9 is a perspective view of a bottom surface of a dust separation unit according to embodiments of the present disclosure. FIG. 10 is a front view of a dust separation unit according to embodiments of the present disclosure. FIG. 11 is a diagram to describe air flow sucked into a cyclone body according to embodiments of the present disclosure.

Hereinafter, the second cyclone part of the cleaner according to the first embodiment of the present disclosure will be described with reference to FIGS. 5 to 11.

After dust is separated from the air by the first cyclone part 113, the air discharged from the first cyclone part 113 may be introduced into the second cyclone part 200 along the flow path.

The second cyclone part 200 may be arranged at least partially inside the first cyclone part 113 and can separate dust from the air discharged from the first cyclone part 113.

The second cyclone part 200 may be formed by a set of axial cyclones formed to separate dust from air flowing in the axial direction. The set of axial cyclones may include the cyclone body 210 and the dust separation part 220.

The second cyclone part 200 may include a cyclone body 210, a dust separation portion 220, and a guide vane 230.

The cyclone body 210 is configured to apply the principle of a dust collector that uses centrifugal force to separate dust from air discharged from the first cyclone part 113. A space in which air can flow may be formed inside the cyclone body 210, and air discharged from the first cyclone part 113 may be introduced into the inside of the cyclone body 210.

The cyclone body 210 may be arranged inside the filter part 170. Specifically, at least a portion of the cyclone body 210 may be disposed inside the filter body 171, and air passing through the filter hole 171a may be introduced into the inside of the cyclone body 210.

A plurality of cyclone bodies 210 may be provided. Each cyclone body 210 may be formed with an inlet 210a forming an outer wall around the hollow portion. The outer walls around the hollow portion formed by the cyclone body 210 may correspond to the outer walls of each axial cyclone. Air discharged from the first cyclone part 113 may be introduced into the inside of the cyclone body 210 through the inlet 210a. Air circulating along the inner surface of the cyclone body 210 may form a cyclone flow.

Dust heavier than air may rotate within the circulating flow while drawing a larger rotation radius than air. Since the dust rotates inside the cyclone body 210, the maximum rotation radius of the dust may be defined by the cyclone body 210.

The lower portion of the cyclone body 210 may have a slanted shape that becomes narrower as it goes down. The lower portion of the cyclone body 210 has a shape that becomes narrower as it goes down to induce the falling of dust separated from the air and prevent the dust from being discharged along the air to the vortex finder 221.

The lower portion of the cyclone body 210 may be supported by a plate member 240. The plate member 240 may be arranged to surround the outer surface of each cyclone body 210. The plate member 240 may have a plurality of through holes formed at positions facing the cyclone body 210, and the lower part of the cyclone body 210 may be inserted into each of the through holes. Since the lower portion of the cyclone body 210 has an inclined shape that becomes narrower as it goes down, the cyclone body 210 may be supported by the plate member 240 at a position where the outer surface of the cyclone body 210 and the size of the through hole are the same.

The plate member 240 may have a fixing groove (not shown). The fixing groove may be arranged along the outer surface of the plate member 240, and the fixing groove may be coupled to a fixing protrusion (not shown) arranged on the inner surface of the filter body 171 so that the coupling position is set and arbitrary relative rotation is prevented. Since arbitrary relative rotation may occur between the dust separation part 220 and the filter body 171, arbitrary relative rotation must be prevented for normal operation of the second cyclone part 200.

The fixing projection of the filter body 171 is formed to be insertable into the fixing groove, and may be formed on either the plate member 240 or the filter body 171. The fixing groove of the plate member 240 is formed to accommodate the fixing projection of the filter body 171, and may be formed on the other of the plate member 240 or the filter body 171). In addition, the fixing groove of the plate member 240 and the fixing projection of the filter body 171 may be provided in multiple numbers.

An outlet 210b may be formed at the bottom of the cyclone body 210. That is, dust separated from the air inside the cyclone body 210 may be discharged from the cyclone body 210 through the outlet 210b. In addition, the bottom of the cyclone body 210 may be communicated with the internal space of the storage member 172. Therefore, dust rotating along the vortex inside the cyclone body 210 may fall and be stored in the storage member 172. The dust stored in the storage member 172 may be connected to the external space when the discharge cover 122 is opened.

The upper portion of the cyclone body 210 may be formed to accommodate the vortex finder 221. The upper portion of the cyclone body 210 may be formed to have a constant inner diameter. The upper portion and the lower portion of the cyclone body 210 may be distinguished based on the position where the inner diameter narrows.

The outer surface of each cyclone body 210 is connected to be in contact with the surrounding cyclone bodies 210, so that a plurality of cyclone bodies 210 can form one member. It is preferable that the cross section of each cyclone body 210 has a circular shape as shown in the drawing. This is because when the cross-section of the cyclone body 210 is formed in a circular shape, even if the outer surfaces of adjacent cyclone bodies 210 are in close contact with each other, a path for air and dust may be formed between them. When a path for air and dust is formed between cyclone bodies 210, there is an advantage in that a separate path structure does not need to be installed.

It is not excluded that the cross-section of each cyclone body 210 is formed as a polygon. However, even if the cross-section of each cyclone body 210 is formed as a polygon, it is preferable that it is formed as a polygon in which air and dust paths may be formed.

The dust separation part 220 may be placed on the cyclone body 210 to form a set of axial cyclones together with the cyclone body 210. The cyclone body 210 may form a part of the set, and the dust separation part 220 may form the remaining part of the set. That is, a set of axial cyclones may be formed by a plurality of cyclone bodies 210 and one member.

The dust separation part 220 may include the vortex finder 221, a band member 222, a frame member 223, and a fixing member 224. Since the dust separation part may be a single integral member, the vortex finder 221, the band member 222, the frame member 223, and the fixing member 224 may mean each part of the dust separation part 220.

The vortex finder 221 is configured to discharge air that has passed through the cyclone flow inside the cyclone body 210. A path through which air can flow may be formed inside the vortex finder 221. A plurality of vortex finders 221 may be provided, and at least a portion of each vortex finder 221 may be placed inside each cyclone body 210. The outer surface of each vortex finder 221 may be spaced apart from the inner surface of each cyclone body 210. Each vortex finder 221 has an entrance 221a forming an outer wall around the hollow portion, and air passing through the cyclone body 210 may be discharged through the inlet hole 221a of each vortex finder 221. In addition, air flowing into the inlet hole 221a may flow upward through the vortex finder 221 and be discharged through an outlet hole 221b.

The lower portion of the vortex finder 221 may have a higher height than the band member 222. However, the upper portion of the vortex finder 221 may have the same height as the band member 222. It may be seen from the drawing that the bottom of the vortex finder 221 protrudes below the dust separation part 220, but the top does not.

It is preferable that the cross section of each vortex finder 221 has a circular ring shape. It is not excluded that the cross section of each vortex finder 221 is formed as a polygon. However, even if the cross section of each vortex finder 221 is formed as a polygon, it is preferable that it is formed as a polygon in which air and dust passages may be formed.

Referring to FIGS. 8 and 9, the inner surface 221c of the vortex finder 221 positioned at a height corresponding to the second guide vane 232 may protrude outwardly (radially outwardly of the vortex finder 221). Specifically, the inner surface 221c of the vortex finder 221 positioned at the same height as the second guide vane 232 may be formed to protrude in a shape corresponding to the second guide vane 232.

Due to this structure, the area of the outlet hole 221b of the vortex finder 221 may be larger than the area of the inlet hole 221a of the vortex finder 221. That is, since the cross-sectional area of the flow path increases from the inlet hole 221a of the vortex finder 221 to the outlet hole 221b, there is an effect of reducing the flow loss that may occur when the air flowing into the inlet hole 221a of the vortex finder 221 flows toward the outlet hole 221b. At this time, the inlet hole 221a of the vortex finder 221 means the inlet through which the air passing through the cyclone body 210 flows in, and the outlet hole 221b of the vortex finder 221 means the outlet through which the air passing through the vortex finder 221 is discharge

The band member 222 may be formed to surround the outer surface of the vortex finder 221. At this time, the band member 222 may be named by another name as needed. For example, names such as ring portion, ring portion, frame portion, perimeter portion, circle portion, support portion, connection portion, outer portion, cyclone boundary portion, and outer wall portion may be considered, and other names may also be possible. The band member 222 may be mounted on the filter body 171 and may have a shape corresponding to the upper part of the filter body 171. The upper portion of the filter body 171 may be formed in a circular shape, and the band member 222 may also be formed in a circular shape that surrounds the vortex finder 221. However, this does not exclude the upper portion of the filter body 171 and the band member 222 from being formed in a polygonal shape.

The position fixing step 223a of the dust separation part 220 may be set by fitting into the step (not shown) of the filter body 171 so that the coupling position is set and arbitrary relative rotation is prevented. Since arbitrary relative rotation may occur between the dust separation part 220 and the filter body 171, arbitrary relative rotation must be prevented for normal operation of the second cyclone part 200.

Meanwhile, a fixing member 225 extending downward may be provided at the center of the band member 222. The fixing member 225 may be fitted into a fixing space 211 formed by the outer peripheral surfaces of a plurality of cyclone bodies 210. At this time, the plurality of cyclone bodies 210 may be arranged radially with the fixing member 225 as the center. The fixing member 225 fitted into the fixing space 211 is coupled to a position fixing groove (not shown) formed on the upper surface of the plate member 240 so that the coupling position is set, and arbitrary relative rotation between the dust separation part 220 and the cyclone body 210 may be prevented.

The outer band member 223 may be formed to surround the band member 222 to form a frame of the dust separation part 220. The outer band member 223 may surround the band member 222 at the outer edge of the band member 222. Meanwhile, the outer band member 223 may form a fixing step 222a with the band member 222. That is, since a portion of the side surface of the band member 222 and the lower surface of the outer band member 223 form the fixing step 222a, the filter body 171 may be fitted into the fixing step 222a.

The protruding member 224 may be formed on the upper surface where the outlet hole 221b of the vortex finder 221 is arranged to guide the air discharged through the outlet hole 221b in a certain direction. At this time, the upper and lower parts of the protruding member 224 may have the same height as the outer band member 223. Since the protruding member 224 has the same height as the outer band member 223, the possibility of interference with other parts and the possibility of damage can be reduced.

The vortex finder 221 and the band member 222 are connected to each other, the band member 222 is connected to the second outer band member 223, and the protruding member 224 is connected to the band member 222 and the outer band member 223, so that the dust separation part 220 may be formed as a single integral member.

The guide vane member 230 is configured to guide air discharged from the first cyclone part 113 to the inside of the cyclone body 210. The guide vane member 230 may form a guide path 234 through which air may flow to the inside of the cyclone body 210. Therefore, air flowing along the guide path 234 may form a swirling flow between the vortex finder 221 and the cyclone body 210.

At least a portion of the guide vane member 230 may be arranged between the cyclone body 210 and the vortex finder 221 and be connected to each cyclone body 210 and each vortex finder 221. One side of the guide vane member 230 may be connected to the outer surface of the vortex finder 221 along the spiral direction, and the other side of the guide vane member 230 may be connected to the inner surface of the cyclone body 210 along the spiral direction.

A plurality of guide vane members 230 may be provided for each cyclone body 210 and each vortex finder 221, and the guide vane members 230 may be extended along the spiral direction to generate a swirling flow. As the guide vane member 230 is extended in the spiral direction, the guide path 234 is also extended along the spiral direction, and air and dust introduced into the inlet 210a of the cyclone body 210 may form a swirling flow.

The guide vane member 230 may include a first guide vane 231, a second guide vane 232, and a third guide vane 233. At this time, the guide path 234 defined by the first guide vane 231, the second guide vane 232, the third guide vane 233, and the vortex finder 221 may extend along a spiral direction and guide air discharged from the first cyclone part 113 to the inside of the cyclone body 210.

The first guide vane 231 may be arranged in the cyclone body 210. The first guide vane 231 may be formed integrally with the cyclone body 210. With the vortex finder 221 inserted into the inner side of the cyclone body 210, the first guide vane 231 may be arranged between the vortex finder 221 and the cyclone body 210. One side of the first guide vane 231 may be connected to the outer surface of the vortex finder 221 along a spiral direction, and the other side of the first guide vane 231 may be connected to the inner surface of the cyclone body 210 along a spiral direction.

The second guide vane 232 may be arranged in the vortex finder 221. The second guide vane 232 may be formed integrally with the vortex finder 221. With the vortex finder 221 inserted into the inside of the cyclone body 210, a portion of the lower side of the second guide vane 232 may be placed between the vortex finder 221 and the cyclone body.

As the vortex finder 221 is inserted into the inside of the cyclone body 210, the second guide vane 232 may be continuously extended by coming into contact with the first guide vane 231. In particular, each second guide vane 232 may be formed to be in surface contact with each first guide vane 231.

At this time, the state in which the vortex finder 221 is inserted into the inside of the cyclone body 210 and the first guide vane 231 and the second guide vane 232 are in surface contact may be defined as a state in which the cyclone body 210 and the vortex finder 221 are coupled. The direction in which the cyclone body 210 and the vortex finder 221 are coupled may be formed along the axial direction of the cyclone body 210 and/or the vortex finder 221.

Referring to FIG. 10 and FIG. 11, a step having a shape corresponding to that of the first guide vane 231 may be formed on the second guide vane 232. The step of the second guide vane 232 may be formed to be sunken so as to correspond to the edge of the first guide vane 231. Accordingly, the first guide vane 231 may be engaged with the second guide vane 232.

Specifically, the step of the second guide vane 232 may be provided with a first surface 232a and a second surface 232b. The first surface 232a may correspond to the upper surface of the first guide vane 231. The second surface 232b may correspond to the side of the first guide vane 231 and may be bent downward from the first surface 232a. The second surface 232b may be formed parallel to the direction in which the cyclone body 210 and the vortex finder 221 are coupled.

Due to this structure, the first guide vane 231 and the second guide vane 232 may be coupled more stably, thereby reducing the flow loss of air flowing into the inside of the cyclone body 210.

Meanwhile, referring to FIGS. 10 and 11, at least a portion of the outer surface of the vortex finder 221 may be sunken inward to correspond to the first guide vane 231. That is, a recessed surface 221d corresponding to the shape of the first guide vane 231 may be formed on the outer surface of the vortex finder 221. Accordingly, when the cyclone body 210 and the vortex finder 221 are coupled, the cyclone body 210 is caught by the recessed surface 221d, so that the first guide vane 231 and the second guide vane 232 may be more stably coupled.

The third guide vane 233 may be arranged on the vortex finder 221 so as to be spaced apart from the second guide vane 232 adjacent to it. The third guide vane 233 may be arranged so as to be spaced apart from the second guide vane 232 in a direction perpendicular to the axial direction of the vortex finder 221. According to this configuration, the guide vanes can overlap each other along the coupling direction of the cyclone body 210 and the vortex finder 221. Specifically, the first guide vane 231 and the third guide vane 233 may overlap each other. It can be seen from FIG. 11 that the first guide vane 231 and the third guide vane 233 overlap each other.

Since the dust separation part 220 and the cyclone body 210 manufactured by injection from the upper mold and the lower mold must be separated from the upper mold and the lower mold after injection, the guide vanes cannot overlap each other along the coupling direction of the cyclone body 210 and the vortex finder 221.

However, when the dust separation part 220 and the cyclone body 210 are coupled to each other, the first guide vane 231 and the third guide vane 233 may overlap each other. This is as if one guide vane forms a structure in which it overlaps each other along the axial direction of the other guide vane and the vortex finder 221, the axial direction of the cyclone body 210, or the coupling direction of the dust separation part 220 and the cyclone body 210.

When the first guide vane 231 and the third guide vane 233 overlap each other along the direction of coupling of the cyclone body 210 and the vortex finder 221, a high-speed swirling flow may be formed, thereby realizing high separation performance of the second cyclone part 200.

Hereinafter, the flow of air flowing through the path of the cleaner 100 will be described.

First, when the suction motor 114 is operated, external air may be introduced into the interior of the first cyclone part 113 through the suction port 112.

Air from which dust has been separated by the first cyclone part 113 may pass through the filter hole 171a formed in the filter body 171 and be introduced into the path between the cyclone body 210 and the filter body 171. At this time, a path between the cyclone body 210 and the filter body 171 may be formed between the outer surface of the cyclone body 210 and the inner surface of the filter body 171.

Air passing through the filter hole 171a may flow into the inside of the cyclone body 210 through the inlet 210a of the cyclone body 210 after passing through the passage between the cyclone body 210 and the filter body 171.

Air flowing into the inside of the cyclone body 210 may flow upward after falling while forming a vortex flow and pass through the vortex finder 221. Air passing through the vortex finder 221 may flow toward the suction motor 114 and be discharged to the outside through the HEPA filter and the air discharge hole.

Although the present invention has been described with reference to the exemplified drawings, it is to be understood that the present invention is not limited to the embodiments and drawings disclosed in this specification, and those skilled in the art will appreciate that various modifications are possible without departing from the scope and spirit of the present invention.

Further, although the operating effects according to the configuration of the present invention are not explicitly described while describing an embodiment of the present invention, it should be appreciated that predictable effects are also to be recognized by the configuration.

1. A cleaner comprising:
a suction port configured to guide air into a dust bin;
a first cyclone part configured to separate dust from air sucked in through the suction port; and
a second cyclone part configured to separate dust from air discharged from the first cyclone part,
wherein the second cyclone part comprises,
a cyclone body configured to receive air discharged from the first cyclone part;
a vortex finder having at least a portion disposed on the inside of each cyclone body; and
a guide vane member having at least a portion disposed between the cyclone body and the vortex finder, and configured to guide air discharged from the first cyclone part to the inside of the cyclone body,
wherein the guide vane member comprises,
a first guide vane disposed in the cyclone body; and
a second guide vane disposed in the vortex finder, and
the first guide vane and the second guide vane are in contact and extend continuously.

2. The cleaner of claim 1, wherein the guide vane member further comprises,
a third guide vane arranged in the vortex finder so as to be spaced adjacent to the second guide vane, and
the first guide vane and the third guide vane overlap each other along the coupling direction of the cyclone body and the vortex finder.

3. The cleaner of claim 1, wherein air discharged from the first cyclone part is introduced into the inside of the cyclone body through a guide path formed by the vortex finder and the guide vane member, and the guide path extends along a spiral direction.

4. The cleaner of claim 1, wherein an inner surface of the vortex finder corresponding to the second guide vane protrudes outward.

5. The cleaner of claim 4, wherein the area of the outlet of the above vortex finder is larger than the area of the inlet of the above vortex finder.

6. The cleaner of claim 1, wherein one side of the guide vane member is connected to an outer surface of the vortex finder along a spiral direction, and the other side of the guide vane member is connected to an inner surface of the cyclone body along a spiral direction.

7. The cleaner of claim 1, wherein the first guide vane and the above second guide vane are formed to be in surface contact.

8. The cleaner of claim 7, wherein the second guide vane is formed with a step having a shape corresponding to an edge of one outer surface of the first guide vane.

9. The cleaner of claim 8, wherein the step of the second guide vane comprises,
a first surface corresponding to an upper surface of the first guide vane; and
a second surface corresponding to a side surface of the first guide vane and bent downward from the first surface, and
the first guide vane is in surface contact with the first surface and the second surface.

10. The cleaner of claim 9, wherein the second surface is formed parallel to a coupling direction of the cyclone body and the vortex finder.

11. The cleaner of claim 10, wherein at least a portion of the outer surface of the above vortex finder is recessed inward to correspond to the first guide vane.
